(19) United States
(12) Patent Application Publication
(10) Pub. No.: US 2021/0370555 A1
(43) Pub. Date: Dec. 2, 2021

(54) GLOVE DEMOLDING MECHANISM, GLOVE COUNTING MACHINE AND GLOVE DEMOLDING METHOD

(71) Applicant: QINGDAO SAWOTE ROBOT CO., LTD. (CN), Qingdao (CN)

(72) Inventor: ZEWEI LI, QINGDAO (CN)

(21) Appl. No.: 17/401,220

(22) Filed: Aug. 12, 2021

Related U.S. Application Data
(63) Continuation of application No. PCT/CN2020/136100, filed on Dec. 14, 2020.

(30) Foreign Application Priority Data
Dec. 31, 2019 (CN) 201911417322.5
Dec. 31, 2019 (CN) 201922490210.4
Dec. 31, 2019 (CN) 201922495830.7

(51) Int. Cl. B29C 41/42; B29C 41/02

(52) U.S. Cl. CPC B29C 41/42; B29L 2031/4864; B29C 41/02

(57) ABSTRACT

The application discloses a glove demolding mechanism, a glove counting machine and a glove demolding method. The glove demolding mechanism includes a glove demolding unit, a first induction device and a vertical power assembly, the glove demolding unit is fixed on the vertical power assembly, and the vertical power assembly is capable of driving the glove demolding unit to move vertically, the first induction device is arranged at a position away from rear ends of the glove demolding units for a set distance, and the glove demolding unit can move upwards to the appropriate position under the bottom of gloves to clamp the gloves driving by the vertical power assembly. When the glove demolding mechanism is used to separate the gloves from hand molds, the gloves can be more ordered.

### CROSS-REFERENCE TO RELATED APPLICATION

The present application is a continuation application of international application No. PCT/CN2020/136100, filed on Dec. 14, 2020, which claims the priority benefits of Chinese applications No. 201922490210.4, No. 201911417322.5, and No. 201922495830.7 field on Dec. 31, 2019, the contents of the above identified applications are hereby incorporated by reference in their entirety.

### TECHNICAL FIELD

The present application relates to the technical field of automatic production equipment of gloves, in particular to a glove demolding mechanism, a glove counting machine and a glove demolding method.

### BACKGROUND

In an automatic production line of gloves, there is a very important operation that gloves are picked from hand molds so as to be completely separated from the hand molds. In an existing glove demolding mechanism, two rollers capable of relatively moving are generally used, when gloves arrive at specified positions the two rollers close to each other until the gloves are clamped, the gloves are fixed by a pressure between the two rollers so as not to move with the hand molds any more, thereby realizing complete separation of the gloves from the hand molds. Different gloves are clamped by the rollers at the same time, and the clamped positions of the gloves are inconsistent, and therefore, the picked gloves are rather disordered when the gloves are picked by using such a technology; and it takes a lot of efforts to sort out the gloves during the packing of the gloves, which results in time and manpower waste.

### SUMMARY

In view of the problems exist in the prior art, the present application provides a glove demolding mechanism, a glove counting machine and a glove demolding method.

The technical solutions provided by the present application are as following.

A glove demolding mechanism, comprising glove demolding units, a first induction device and a vertical power assembly, the glove demolding units are fixed to the vertical power assembly, the vertical power assembly is capable of driving the glove demolding units to move in vertical direction, and the first induction device is arranged at a position away from rear ends of the glove demolding units for a set distance; when gloves run in an induction region of the first induction device, the first induction device induces heights H of the lowest ends of the gloves; the glove demolding units is capable of moving upwards to position at the heights H driving by the vertical power assembly to clamp the gloves and moving downwards driving by the vertical power assembly so that the gloves are separated from hand molds.

In some embodiments of the present application, the glove demolding mechanism comprises a first driving member and two clamping jaws, the two clamping jaws are respectively fixed to a left side and a right side of the first driving member and the first driving member is capable of driving the two clamping jaws to open or close.

In some embodiments of the present application, the glove demolding mechanism comprises a horizontal power assembly connected with the vertical power assembly;

a second induction device arranged on an suitable position at the rear ends of the glove demolding units, the second induction device comprises a counting induction member for counting the hand molds moving into an induction range.

In some embodiments of the present application, when the counting induction member induces that the last hand mold of the hand molds passing, the horizontal power assembly drives the glove demolding units to synchronously move forwards together with the hand molds, and the vertical power assembly drives the glove demolding units to move upwards;

when the glove demolding units move upwards to the position at the heights H of the hand molds induced by the first induction device, the first driving members drive the clamping jaws to be closed to clamp the gloves;

when the glove demolding units move forwards to first positions, the horizontal power assembly decelerates till stop moving, and meanwhile, the vertical power assembly drives the glove demolding units to move downwards to pull downwards the gloves from the hand molds.

In some embodiments of the present application, the glove demolding mechanism comprises a second driving member connected with the first driving member and is capable of driving the first driving member to rotate;

when the glove demolding units move downwards to second positions, the horizontal power assembly drives the glove demolding units to move backwards, the second driving members drive the first driving members to rotate downwards and then drive the clamping jaws to rotate downwards, so that the gloves on the clamping jaws are located at front ends of the glove demolding units.

In some embodiments of the present application, the glove demolding mechanism comprises temporary glove storage mechanisms arranged on suitable positions below the glove demolding units for storing the gloves separated from the hand molds;

when the glove demolding units move downwards to second positions, the horizontal power assembly drives the glove demolding units to move backwards, the second driving members drive the first driving members to rotate downwards and then drive the clamping jaws to rotate downwards, so that the gloves on the clamping jaws are located at front ends of the glove demolding units; then, the horizontal power assembly drives the glove demolding units to continue to move backwards, and the gloves are dragged backwards until the gloves completely enter the temporary glove storage mechanisms; and then, the first driving members drive the clamping jaws to be opened, so that the gloves are placed in the temporary glove storage mechanisms.

In some embodiments of the present application, each of the temporary glove storage mechanisms comprises bottom plate driving members, bottom plates and a frame, the bottom plate driving members are fixed to sides of the frame, the bottom plates are fixed to the bottom plate driving members, and the bottom plate driving members is capable of driving the bottom plates to be close to or away from the frame, thereby realizing the opening/closing of the bottom plates;

when the bottom plates are closed, the bottom plates and the frame form a container without a box cover to temporarily store picked gloves; and when temporarily stored gloves reach a set number, the bottom plates are opened, the gloves are separated from the temporary glove storage mechanisms.

In some embodiments of the present application, the second induction device further comprises a speed induction member for inducing forward motion speeds of the hand molds in real time, and information induced by the speed induction member is used for regulating forward motion speeds of the glove demolding units driven by the horizontal power assembly to ensure that the glove demolding units and the hand molds synchronously move forwards.

The present application further provides a glove counting machine, comprising the glove demolding mechanism described above, further comprises delivery mechanisms;

each of the delivery mechanisms comprises delivery assemblies and storage boxes arranged on the delivery assembly, the storage boxes are located below the temporary glove storage mechanisms, the number of the delivery assemblies is consistent with that of the temporary glove storage mechanisms, and the delivery assemblies is capable of driving the storage boxes to do straight reciprocating motion in a direction away from/close to the temporary glove storage mechanisms.

In some embodiments of the present application, the glove counting machine comprises a transfer mechanism, the transfer mechanism comprises a horizontal moving assembly, a vertical moving assembly and fetching jaws, the vertical moving assembly is arranged on the horizontal moving assembly, the fetching jaws are arranged on the vertical moving assembly, the horizontal moving assembly is capable of driving the vertical moving assembly to do straight reciprocating motion in horizontal direction, and the vertical moving assembly is capable of driving the fetching jaws to do straight reciprocating motion in vertical direction.

In some embodiments of the present application, the fetching jaws are connected with the vertical moving assembly by a rotating member and the rotating member is capable of driving the fetching jaws to rotate.

In some embodiments of the present application, the transfer mechanism further comprises a third driving member, the fetching jaws are arranged at two sides of the third driving member, the third driving member is connected with the rotating member, and the third driving member drives the fetching jaws to be opened or closed.

The present application also provides a glove demolding method, which can be used in the glove demolding mechanism described above, specifically comprising the following steps:

a horizontal power assembly drives glove demolding units and hand molds to synchronously move forwards;

a vertical power assembly drives the glove demolding units to move upwards to positions at heights H of the lowest ends of gloves, first driving members drive clamping jaws to be closed to clamp the gloves;

when the glove demolding units move forwards to first positions, the horizontal moving assembly decelerates till stops moving, and meanwhile, the vertical power assembly drives the glove demolding units to move downwards to pull downwards the gloves from the hand molds;

when the glove demolding units move downwards to second positions, the horizontal power assembly drives the glove demolding units to move backwards, second driving members drive the first driving members to rotate downwards and then drive the clamping jaws to rotate downwards, so that the gloves on the clamping jaws are located at front ends of the glove demolding units; and

the horizontal power assembly drives the glove demolding units to continue to move backwards, and the gloves are dragged backwards until the gloves completely enter temporary glove storage mechanisms, and then, the first driving members drive the clamping jaws to be opened, so that the gloves are placed in the temporary glove storage mechanisms.

Compared with the prior art, this application has the beneficial effects that:

glove demolding units may regulate positions according to heights of the lowest ends of gloves induced by a first induction device, so that every time glove positions clamped by a glove demolding mechanism are kept to be adapted to the positions of the gloves, the gloves separated from hand molds are more ordered, which facilitates the subsequent sorting and packing of the demolded gloves.

A horizontal power assembly may ensure that the glove demolding units and the hand molds synchronously move and may realize the demolding of a plurality of gloves in the process of the hand molds advance, so that the advancing speeds of the hand molds are not affected while demolding is completed, and the efficiency of demolding process is increased.

Clamping jaws are drove to rotate by second driving members, so that relative positions of the demolded gloves and the glove demolding units are kept uniform, which facilitates the subsequent regulation for stacking modes of the gloves. For example, the gloves may be stacked in an end-to-end staggering mode or in an end-to-end cocurrent mode.

Temporary glove storage mechanisms are arranged, before the demolded gloves enter the temporary glove storage mechanisms, the horizontal power assembly may drag the gloves to further spread, and thus, the gloves entering the temporary glove storage mechanisms are in a spread state and are more ordered.

### BRIEF DESCRIPTION OF THE DRAWINGS

FIG. 1 is a schematic structural diagram of a glove demolding mechanism according to an embodiment of the present application;

FIG. 2 is another schematic structural diagram of a glove demolding mechanism according to an embodiment of the present application;

FIG. 3 is a partially enlarged view of a portion A in FIG. 2;

FIG. 4 is schematic structural diagram of a glove demolding mechanism according to an embodiment of the present application;

FIG. 5 is a schematic structural diagram of a glove demolding mechanism according to an embodiment of the present application;

FIG. 6 is a schematic structural diagram of a glove counting machine according to an embodiment of the present application;

FIG. 7 is a schematic structural diagram of a delivery mechanism and a transfer mechanism according to an embodiment of the present application;

FIG. 8 is a partial schematic structural diagram of a transfer mechanism according to an embodiment of the present application;

in which: 1, glove demolding unit; 11, first driving member; 12, clamping jaw; 13, second driving member; 2, first induction device; 21, photoelectric sensor; 22, light guide plate; 3, vertical power assembly; 31, first thread bar; 32, first motor; 33, first mounting frame; 34, first sliding block; 4, horizontal power assembly; 41, second thread bar; 42, second motor; 43, second mounting frame; 44, second sliding block; 5, second induction device; 51, counting induction member, 52, speed induction member; 6, temporary glove storage mechanism; 61, bottom plate driving member; 62, bottom plate; 63, frame; 64, main frame; 7, delivery mechanism; 71, delivery assembly; 711, air cylinder; 712, delivery track; 713, third sliding block; 72, storage box; 8, transfer mechanism; 81, horizontal moving assembly; 811, third motor; 812, third thread bar; 82, vertical moving assembly; 821, fourth motor; 822, fourth thread bar; 83, fetching jaw; 831, cross bar; 832, clamping portion; 84, rotating member; 85, third driving member; and 86, pressing plate.

### DETAILED DESCRIPTION OF THE EMBODIMENTS

The following is a detailed description for the technical solutions of the present application in combination with specific implementations. However, it should be understood that, without further recitation, elements, structures and features in one implementation may be beneficially incorporated into other implementations.

In the description of the present application, it is to be understood that terms “first”, “second” and the like are merely used for descriptive purpose and should not be interpreted to indicate or imply the relative importance or implicitly indicate the number of technical features indicated. Thus, the features defined by “first”, “second” and the like may explicitly or implicitly include one or more of the features.

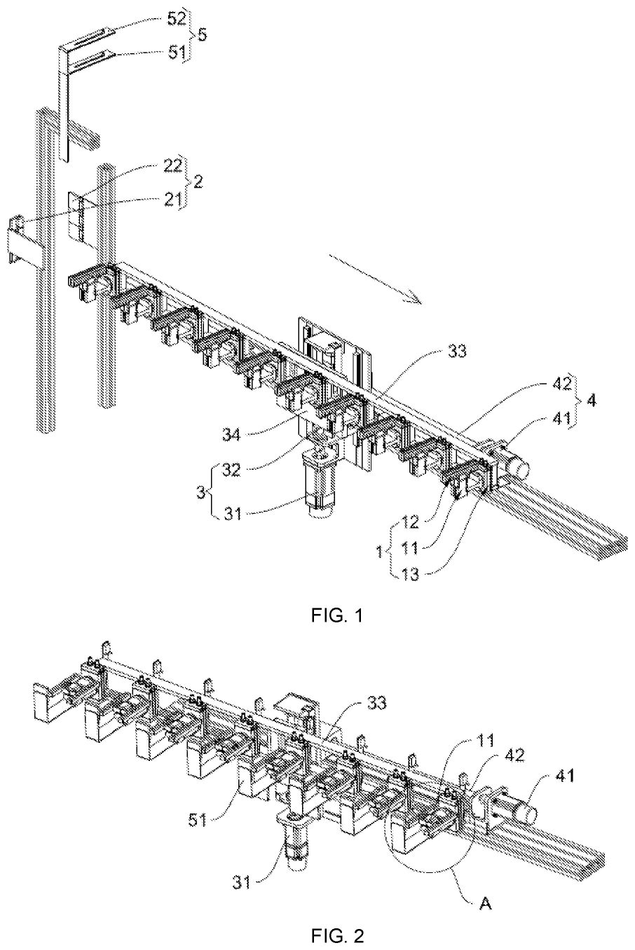

In the description of the present application, it is to be noted that the direction or positional relationships indicated by terms “upper”, “lower” and the like are based on the positional relationships in FIG. 1, these terms are merely used to facilitate the description of the present application and simplify the description, yet do not indicate or imply that the devices or elements referred must have a particular orientation, be constructed and operated in particular orientation, and therefore should not be interpreted as a limitation on this application.

In the description of the present application, it is to be noted that, unless clearly indicates otherwise, terms “connect”, “connection” shall be generally understood, such as, may be fixed connection, detachable connection or integrated connection, may be directly connected, or indirectly connected through intermediate media, or inner communication of two components. For the person skilled in the art, the specific meanings of the above terms in the present application may be interpreted according to specific circumstance.

The implementations are only description for the preferred embodiments of the present application, not a limitation on the scope of the present application, without departing from the design spirit of the present application, all kinds of transformation and modification made by the person skilled in the art to the technical solution of the present application should fall within the protection scope defined by claims of the present application.

Hand molds sleeved with rubber gloves are generally placed to be vertical and are arranged in groups. A hand mold group includes a plurality of hand molds which vertically point at the downside so as to facilitate demolding downwards. In order to facilitate description, hereinafter, the hand molds are used as carriers of to-be-demolded gloves to describe a glove demolding mechanism provided by the present application. The end where the hand molds are removed out of the glove demolding mechanism is defined as a front end, and the end where the hand molds enter the glove demolding mechanism is defined as a rear end.

As shown in FIG. 1 and FIG. 2, an implementation of the present application provides a glove demolding mechanism, comprising glove demolding units 1, a first induction device 2 and a vertical power assembly 3, wherein the glove demolding units 1 are fixed to the vertical power assembly 3, the vertical power assembly 3 is capable of driving the glove demolding units 1 to move in vertical direction, and the first induction device 2 is arranged at a position away from rear ends of the glove demolding units 1 for a set distance; when gloves run in an induction region of the first induction device 2, the first induction device 2 induces heights H of the lowest ends of the gloves; the glove demolding units 1 is capable of moving upwards to position at the heights H driving by the vertical power assembly 3 to clamp the gloves, and moving downwards driving by the vertical power assembly 3 so that the gloves are separated from hand molds. A direction indicated by an arrow in the FIG. 1 is an advancing direction of the hand molds.

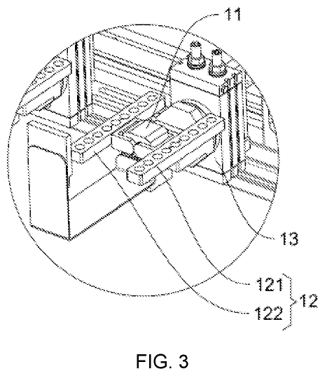

As shown in FIG. 3, each of the glove demolding units 1 comprises a first driving member 11 and two clamping jaws 12, the two clamping jaws 12 are respectively fixed to a left side and a right side of the first driving member 11, and the first driving member 11 is capable of driving the two clamping jaws 12 to open or close, thereby realizing the clamp and release of the gloves. In the present implementation, the first driving member 11 is a clamping cylinder. The two clamping jaws 12 are respectively a first clamping jaw 121 and a second clamping jaw 122; the surface, which is in contact with the gloves, of the first clamping jaw 121 is provided with a convex structure; and the surface, which is in contact with the gloves, of the second clamping jaw 122 is provided with a concave structure matched with the convex structure. When the gloves are clamped by the clamping jaws, the concave structure and the convex structure on the clamping jaws are matched, so that the gloves can be further fastened firmly and prevented from sliding out of the clamping jaws. Both of the first clamping jaw 121 and the second clamping jaw 122 is provided with a hollow structure by which the weights of the clamping jaws are reduced, in this way, power for driving the clamping jaws is smaller, and the glove demolding units 1 are longer in service life and reduced in fault rate. The positions where the glove demolding units 1 move upwards ensure that parts, located at the lowest ends of the gloves may be clamped by the clamping jaws, and the gloves may be still firmly clamped by the clamping jaws when the glove demolding units 1 move downwards. For example, the glove demolding units 1 move upwards to set positions so that the lengths at the lowest ends of the gloves which may be clamped by the clamping jaws are 5-10 mm.

As shown in FIG. 3, each of the glove demolding units 1 further comprises a second driving member 13 connected with the first driving member 11 and is capable of driving the first driving member 11 to rotate. After the gloves are clamped by the clamping jaws 12, the second driving members 13 rotate to drive the first driving members 11 to rotate, thereby driving the clamping jaws 12 to rotate, so that the gloves are located at one side of each of the glove demolding units 1, which is convenient for the gloves to be smoothly separated from the clamping jaws 12 when the clamping jaws 12 unclamp subsequently. In the present implementation, the second driving members 13 are rotary cylinders, and the first driving members 11 are fixed to rotating ends of the rotary cylinders. In the present implementation, rotating angles of the second driving members 13 are 180°. Of course, the rotating angles of the second driving members 13 may also be other angles, such as 190°, 150° and 120°, which may be specifically set according to an actual working condition demand of glove demolding.

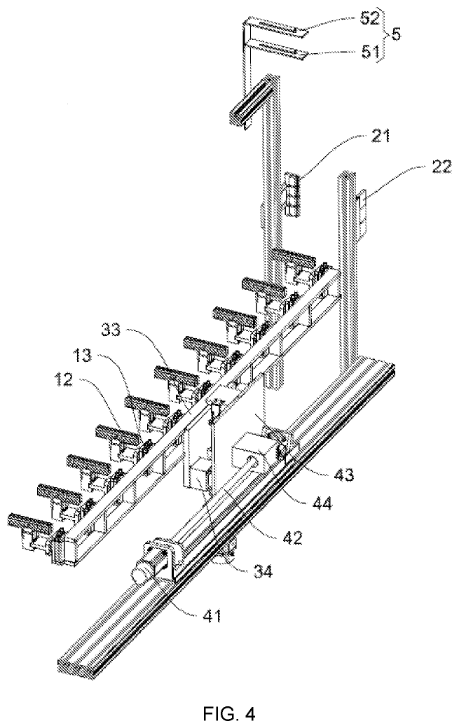

As shown in FIG. 1 and FIG. 2, the glove demolding units 1 are connected with the vertical power assembly 3, and the vertical power assembly 3 is capable of driving the glove demolding units 3 to move in the veridical direction. In the present implementation, the vertical power assembly 3 comprises a first thread bar 31 and a first motor 32, and the first motor 32 is connected with the glove demolding units 1 by the first thread bar 31. Specifically, as shown in FIG. 1 to FIG. 3, a plurality of groups of glove demolding units 1 may be arranged, the number of the glove demolding units 1 corresponds to that of the hand molds of the hand mold group, the second driving members 13 of the plurality of groups of glove demolding units 1 are all connected with the first thread bar 31, thereby realize simultaneously demolding the gloves on the plurality of hand molds. As shown in FIG. 4, the plurality of groups of glove demolding units 1 are arranged on a first mounting frame 33, the first mounting frame 33 is connected with a first sliding block 34 sleeving the first thread bar 31, and the first sliding block 34 is capable of moving along the first thread bar 31 under the drive of the first motor 32. The first induction device 2 is arranged at a suitable distance from the rear ends of the glove demolding units 1, the first induction device 2 is capable of inducing the heights H of the lowest ends of the gloves, and when the glove demolding units 1 move upwards to the position at the heights H, the two clamping jaws 12 are closed to clamp the gloves. The positions of the gloves clamped by the glove demolding units 1 are controlled according to height information of the lowest ends of the gloves, induced by the first induction device 2, thereby ensuring the clamped part of each glove is on the positions at the lowest ends of the gloves, and the gloves after demolding are more ordered. As shown in FIG. 1 and FIG. 4, in the present implementation, the first induction device 2 comprises photoelectric sensor 21 and light guide plate 22, and the photoelectric sensor 21 and light guide plate 22 are arranged oppositely; both the photoelectric sensor 21 and the light guide plates 22 are not less than one. When the gloves pass through the first induction device 2, rays of the light guide plates 22 is shielded, then, light intensity induced by the photoelectric sensor 21 is changed, and the photoelectric sensor 21 induces the heights H of the lowest ends of the gloves according to the change of the light intensity.

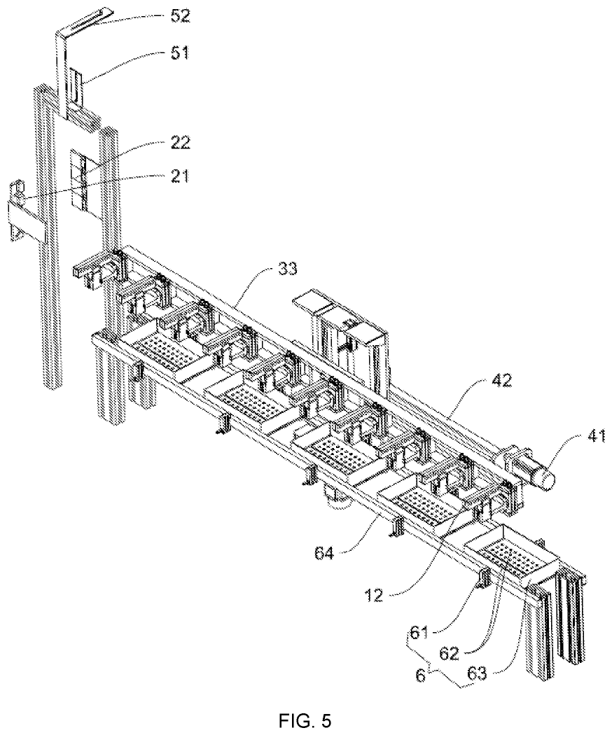

As shown in FIG. 1 to FIG. 4, the glove demolding mechanism further comprises a horizontal power assembly 4 connected with the vertical power assembly 3. The horizontal power assembly 4 comprises a second thread bar 41 and a second motor 42, and the second motor 42 is connected with the vertical power assembly 3 by the second thread bar 41. Specifically, as shown in FIG. 4, the vertical power assembly 3 is arranged on a second mounting frame 43, the second mounting frame 43 is connected with a second sliding block 44 sleeving the second thread bar 41, and the second sliding block 44 is capable of moving along the second thread bar 41 under the drive of the second motor 42. As shown in FIG. 1, FIG. 4 and FIG. 5, the glove demolding mechanism further comprises a second induction device 5 arranged on an suitable position at the rear ends of the glove demolding units 1, the second induction device 5 comprises a counting induction member 51 for counting the hand molds moving into an induction range. Counting information induced by the second induction device 5 is used for regulating motion states of the glove demolding units 1 to realize clamping or releasing of the gloves. As shown in FIG. 5, the glove demolding mechanism further comprises temporary glove storage mechanisms 6 arranged on suitable positions below the glove demolding units 1 for storing the gloves separated from the hand molds.

The hand molds run into the induction range of the counting induction member 51, when the counting induction member 51 induces that the last hand mold of the hand molds passing, the horizontal power assembly 4 drives the glove demolding units 1 to synchronously move forwards together with the hand molds, and the vertical power assembly 13 drives the glove demolding units 1 to move upwards; when the glove demolding units 1 move upwards to the position at the heights H of the hand molds induced by the first induction device 2, the first driving members 11 drive the clamping jaws 12 to be closed to clamp the gloves; when the glove demolding units 1 move forwards to first positions, the horizontal power assembly 4 decelerates till stop moving, and meanwhile, the vertical power assembly 3 drives the glove demolding units 1 to move downwards to pull downwards the gloves from the hand molds, so that the gloves are separated from the hand molds, at the moment, all the gloves are kept in a state that the lowest ends are clamped, and the gloves are more ordered. When the glove demolding units move forwards to the first positions, the clamping jaws have completely clamped lower parts of the gloves. In actual applications, the suitable first positions are set according to forward motion speeds of the hand molds and the clamping speeds of the clamping jaws.

When the glove demolding units 1 move downwards to second positions, the horizontal power assembly 4 drives the glove demolding units 1 to move backwards, the second driving members 13 drive the first driving members 11 to rotate downwards and then drive the clamping jaws 12 to rotate downwards, so that the gloves on the clamping jaws 12 are located at front ends of the glove demolding units 1; then, the horizontal power assembly 4 drives the glove demolding units 1 to continue to move backwards, and the gloves are dragged backwards until the gloves completely enter the temporary glove storage mechanisms 6; and then, the first driving members 11 drive the clamping jaws 12 to be opened, so that the gloves are placed in the temporary glove storage mechanisms 6. The first driving members 11 rotate downwards from the front ends of the glove demolding units 1 to make the gloves swing towards the front ends, and thus, the gloves in the clamping jaws 12 are located at the front ends of the glove demolding units 1. When the gloves enter the temporary glove storage mechanisms 6, there is a process of dragging the gloves backwards, the shape regulation of the gloves is realized in the dragging process, the gloves are in a spread state when being placed, and therefore, the finally stacked gloves are relatively ordered. When the glove demolding units move downwards to the second positions, the gloves are completely separated from the hand molds. During actual applications, the suitable second positions are set according to sizes of the gloves and the hand molds.

There are a plurality of hand molds in the hand mold group. The setting hand molds number of the counting induction member 51 is the same as that of the glove demolding units 1, after a period of time from the moment that the counting induction member 51 inducing the last hand mold of the hand mold group, the horizontal power assembly 4 drives the glove demolding units 1 and the hand mold to synchronously move forwards, so that the glove demolding units are aligned with the hand molds. The time interval is set according to a distance between the counting induction member 51 and the glove demolding unit 1 at the rearmost end and advancing speeds of the hand molds and is generally 1 s-3 s. For example, in FIG. 5, the hand mold group includes 10 hand molds, when the tenth hand mold passes by the counting induction member 51, after 1.5 s, the tenth hand mold is aligned with the tenth glove demolding unit 1, and the horizontal power assembly 4 drives the glove demolding unit 1 to synchronously move forwards together with the hand mold.

As shown in FIG. 5, each of the temporary glove storage mechanisms 6 comprises bottom plate driving members 61, bottom plates 62 and a frame 63, the bottom plate driving members 61 are fixed to sides of the frame 63, the bottom plates 62 are fixed to the bottom plate driving members 61, and the bottom plate driving members 61 is capable of driving the bottom plates 62 to be close to or away from the frame 63, thereby realizing the opening/closing of the bottom plates 62. When the bottom plates 62 are closed, the bottom plates 62 and the frame 63 form a container without a box cover to temporarily store picked gloves; and when temporarily stored gloves reach a set number, the bottom plates 62 are opened, the gloves are separated from the temporary glove storage mechanisms 6 so as to be treated in next step. After the temporary glove storage mechanisms 6 output the gloves, the bottom plate driving members 61 drive the bottom plates 62 to be closed to further provide glove placing spaces for the glove demolding units 1 which continuously operate.

As shown in FIG. 5, the temporary glove storage mechanisms 6 are fixed to a main frame 64 which is in contact with the ground and is used for supporting the temporary glove storage mechanisms 6. The frames 63 are fixed to the main frame 64, and the bottom plate driving members 61 are fixed on the main frame 64, thereby being located on the sides of the frames 63. The glove demolding units 1 are further fixedly provided with a counting induction member 51, the counting induction member 51 is connected with the bottom plate driving members 61 and is used for calculating the number of gloves completely demolded by the corresponding glove demolding units 1, and when the number of the gloves which are completely demolded reaches the set number, the bottom plate driving members 61 drive the bottom plates 62 to be opened, so that the number of the gloves output by the temporary glove storage mechanisms 6 is kept at a constant value. Since the bottom plates 62 may be opened only when the number of the gloves in the temporary glove storage mechanisms reaches the set number, the number of the gloves is guaranteed.

As shown in FIG. 5, there are two bottom plate driving members 61 and two bottom plates 62, the two bottom plate driving members 61 are oppositely arranged at two sides of the frame 63, and the two bottom plates 62 are respectively fixed to the two bottom plate driving members 61. In the present implementation, the bottom plate driving members 61 are clamping cylinder, and the bottom plates 62 are fixed to clamping jaws at one side of the clamping jaw cylinders close to the frame 63.

As shown in FIG. 5, in the present implementation, the number of the temporary glove storage mechanisms 6 is a half of the number of the glove demolding units 1, that is, two of the glove demolding units 1 deliver gloves to one of the temporary glove storage mechanisms 6. When the glove demolding units 1 drag gloves into the temporary glove storage mechanisms 6, every two of the glove demolding units share one of the temporary glove storage mechanisms 6; in the process of dragging the gloves backwards, the glove in the glove demolding unit 1 at the rear end enters the temporary glove storage mechanism 6 firstly, then, the glove in the glove demolding unit 1 at the front end enters the temporary glove storage mechanism 6, and the two gloves enter the temporary glove storage mechanism 6 at a time, so that the efficiency is increased. For example, it may be set that the temporary glove storage mechanisms 6 output twenty-five gloves every time and each of the temporary glove storage mechanisms 6 is fed by two of the glove demolding units 1, when the glove demolding unit 1 close to the rear end completes the demolding of the thirteenth glove, there have been twenty-five gloves in the temporary glove storage mechanism 6, but the glove demolding unit 1 close to the front end has not dragged the thirteenth glove into the temporary glove storage mechanism 6, at the moment, the bottom plate driving members 61 drive the bottom plates 62 to be opened, the temporary glove storage mechanism 6 outputs twenty-five gloves at a time, and after the 25 gloves are output, the bottom plate driving members 61 drive the bottom plates 62 to be closed to further store gloves.

As shown in FIG. 4 and FIG. 5, the second induction device 5 further comprises a speed induction member 52 for inducing forward motion speeds of the hand molds in real time, and information induced by the speed induction member 52 is used for regulating forward motion speeds of the glove demolding units 1 driven by the horizontal power assembly 4 to ensure that the glove demolding units 1 and the hand molds synchronously move forwards, so that the glove demolding units 1 and the corresponding hand molds are approximately kept to be relatively static, which is beneficial to the clamping of the gloves on the hand molds.

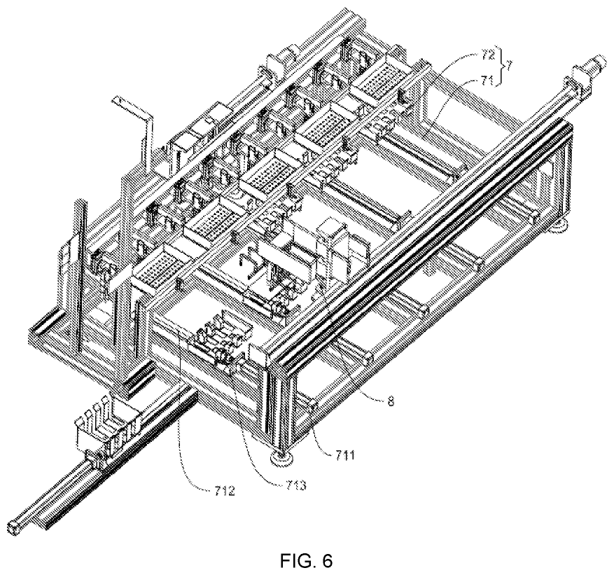

As shown in FIG. 6, the present application further provides a glove counting machine, comprising the glove demolding mechanism described as above and further comprising delivery mechanisms 7. Each of the delivery mechanisms 7 comprises delivery assemblies 71 and storage boxes 72 arranged on the delivery assembly 71, the storage boxes 72 are located below the temporary glove storage mechanisms 6, the number of the delivery assemblies 71 is consistent with that of the temporary glove storage mechanisms 6, and the delivery assemblies 71 is capable of driving the storage boxes 72 to do straight reciprocating motion in a direction away from/close to the temporary glove storage mechanisms 6. In the present implementation, each of the delivery assemblies 71 comprises an air cylinder 711, a delivery track 712 and a third sliding block 713, the storage boxes 72 are arranged on the third sliding blocks 713, telescopic ends of the air cylinders 711 are connected with the third sliding blocks 713, and the storage boxes 72 moves reciprocally along the delivery tracks 712 driving by the air cylinders 711, and thus, gloves in the storage boxes 72 are delivered to specified positions so as to be grabbed by a transfer mechanism. The outsides of the delivery tracks may be provided with telescopic protective jackets to prevent impeding of the motion of the third sliding blocks along the delivery tracks caused by falling articles to result in a fault of the overall glove counting machine.

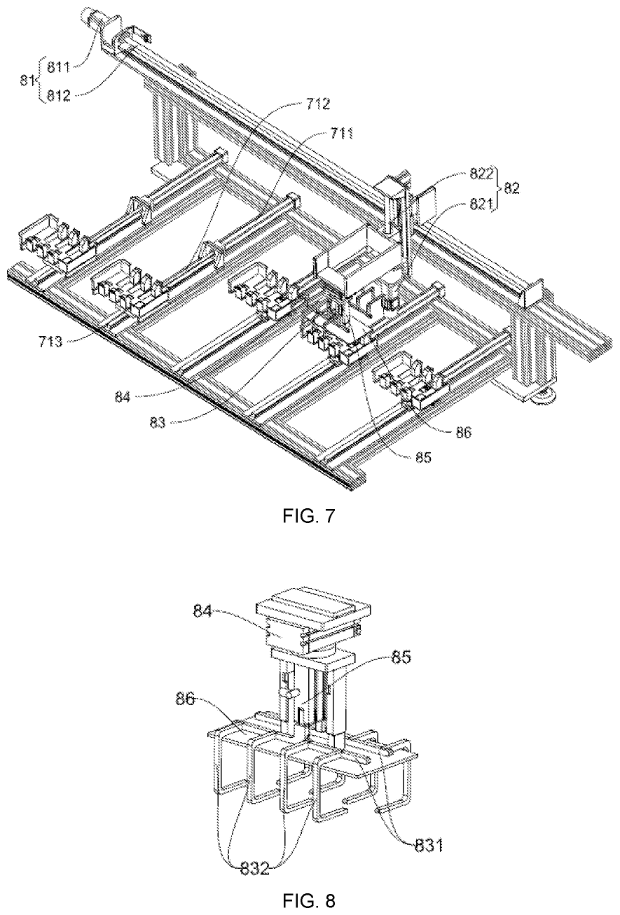

As shown in FIG. 6 and FIG. 7, the glove counting machine further comprises a transfer mechanism 8. The transfer mechanism 8 comprises a horizontal moving assembly 81, a vertical moving assembly 82 and fetching jaws 83, the vertical moving assembly 82 is arranged on the horizontal moving assembly 81, the fetching jaws 83 are arranged on the vertical moving assembly 82, the horizontal moving assembly 81 is capable of driving the vertical moving assembly 82 to do straight reciprocating motion in horizontal direction, and the vertical moving assembly 82 is capable of driving the fetching jaws 83 to do straight reciprocating motion in vertical direction.

As shown in FIG. 7, in the present implementation, the horizontal moving assembly 81 comprises a third motor 811 and a third thread bar 812, the third motor 811 is connected with the vertical moving assembly 82 by the third thread bar 812, and the third motor 811 is capable of driving the vertical moving assembly 82 to do straight reciprocating motion along the third thread bar 812. In the present implementation, the vertical moving assembly 82 comprises a fourth motor 821 and a fourth thread bar 822, the fourth motor 821 is connected with the fetching jaws 83 by the fourth thread bar 822, and the fourth motor 821 drives the fetching jaws 83 to do straight reciprocating motion along the fourth thread bar 812. As a preferred implementation, the fetching jaws 83 are connected with the vertical moving assembly 82 by a rotating member 84, and the rotating member 84 is capable of driving the fetching jaws 83 to rotate at the angle of 180°. The rotating member 84 may be a rotary cylinder, a rotating end of the rotary cylinder is provided with the fetching jaws 83, and a fixed end of the rotary cylinder is arranged on the vertical moving assembly 82.

As shown in FIG. 8, the transfer mechanism 8 further comprises a third driving member 85, the fetching jaws 83 are arranged at two sides of the third driving member 85, the third driving member 85 is connected with the rotating member 84, and the third driving member 85 drives the fetching jaws 83 to be opened or closed. As shown in FIG. 8, a lower part of the third driving member is provided with a pressing plate 86 by which materials are conveniently compacted before being clamped so as to be conveniently clamped by the fetching jaws. The fetching jaws 83 comprise cross bars 831 and a plurality of clamping portions 832 arranged on the cross bars 831, and the clamping portions are U-shaped so as to effectively and firmly grab the materials. The cross bars 831 of the fetching jaws are connected with the third driving member 85 and the cross bars 831 move driving by the third driving member 85, thereby driving the fetching portions 832 to be opened or closed.

This application further provides a glove demolding method in which the above-mentioned glove demolding mechanism is adopted specifically comprising the following steps:

a horizontal power assembly drives glove demolding units and hand molds to synchronously move forwards;

a vertical power assembly drives the glove demolding units to move upwards to positions at heights H of the lowest ends of gloves, first driving members drive clamping jaws to be closed to clamp the gloves;

when the glove demolding units move forwards to first positions, the horizontal moving assembly decelerates till stops moving, and meanwhile, the vertical power assembly drives the glove demolding units to move downwards to pull downwards the gloves from the hand molds;

when the glove demolding units move downwards to second positions, the horizontal power assembly drives the glove demolding units to move backwards, second driving members drive the first driving members to rotate downwards and then drive the clamping jaws to rotate downwards, so that the gloves on the clamping jaws are located at front ends of the glove demolding units; and

the horizontal power assembly drives the glove demolding units to continue to move backwards, and the gloves are dragged backwards until the gloves completely enter temporary glove storage mechanisms, and then, the first driving members drive the clamping jaws to be opened, so that the gloves are placed in the temporary glove storage mechanisms. When the glove demolding units move forwards to the first positions, the clamping jaws have completely clamped lower parts of the gloves. In actual applications, the suitable first positions are set according to the forward motion speeds of the hand molds and the clamping speeds of the clamping jaws. When the glove demolding units move downwards to the second positions, the gloves are completely separated from the hand molds. In actual applications, the suitable second positions are set according to sizes of the gloves and the hand molds.

When the number of gloves in the temporary glove storage mechanisms reaches a preset value, bottom plates of the temporary glove storage mechanisms are opened, so that quantitative gloves in the temporary glove storage mechanisms enter the next process, such as a packaging process.

1. A glove demolding mechanism, comprising glove demolding units, a first induction device and a vertical power assembly, the glove demolding units are fixed to the vertical power assembly, the vertical power assembly is capable of driving the glove demolding units to move in vertical direction, and the first induction device is arranged at a position away from rear ends of the glove demolding units for a set distance; when gloves run in an induction region of the first induction device, the first induction device induces heights H of the lowest ends of the gloves; the glove demolding units is capable of moving upwards to position at the heights H driving by the vertical power assembly to clamp the gloves, and moving downwards driving by the vertical power assembly so that the gloves are separated from hand molds.

2. The glove demolding mechanism of claim 2, further comprising a horizontal power assembly connected with the vertical power assembly;
a second induction device arranged on a suitable position at the rear ends of the glove demolding units, the second induction device comprises a counting induction member for counting the hand molds moving into an induction range.

3. The glove demolding mechanism of claim 2, comprising a first driving member and two clamping jaws, the two clamping jaws are respectively fixed to a left side and a right side of the first driving member and the first driving member is capable of driving the two clamping jaws to open or close.

4. The glove demolding mechanism of claim 2, wherein when the counting induction member induces that the last hand mold of the hand molds passing, the horizontal power assembly drives the glove demolding units to synchronously move forwards together with the hand molds, and the vertical power assembly drives the glove demolding units to move upwards;
when the glove demolding units move upwards to the position at the heights H of the hand molds induced by the first induction device, the first driving members drive the clamping jaws to be closed to clamp the gloves;
when the glove demolding units move forwards to first positions, the horizontal power assembly decelerates till stop moving, and meanwhile, the vertical power assembly drives the glove demolding units to move downwards to pull downwards the gloves from the hand molds.

5. The glove demolding mechanism of claim 4, comprising a second driving member connected with the first driving member and is capable of driving the first driving member to rotate;
when the glove demolding units move downwards to second positions, the horizontal power assembly drives the glove demolding units to move backwards, the second driving members drive the first driving members to rotate downwards and then drive the clamping jaws to rotate downwards, so that the gloves on the clamping jaws are located at front ends of the glove demolding units.

6. The glove demolding mechanism of claim 5, comprising temporary glove storage mechanisms arranged on suitable positions below the glove demolding units for storing the gloves separated from the hand molds;
when the glove demolding units move downwards to second positions, the horizontal power assembly drives the glove demolding units to move backwards, the second driving members drive the first driving members to rotate downwards and then drive the clamping jaws to rotate downwards, so that the gloves on the clamping jaws are located at front ends of the glove demolding units; then, the horizontal power assembly drives the glove demolding units to continue to move backwards, and the gloves are dragged backwards until the gloves completely enter the temporary glove storage mechanisms; and then, the first driving members drive the clamping jaws to be opened, so that the gloves are placed in the temporary glove storage mechanisms.

7. The glove demolding mechanism of claim 6, wherein each of the temporary glove storage mechanisms comprises bottom plate driving members, bottom plates and a frame, the bottom plate driving members are fixed to sides of the frame, the bottom plates are fixed to the bottom plate driving members, and the bottom plate driving members is capable of driving the bottom plates to be close to or away from the frame, thereby realizing the opening/closing of the bottom plates;
when the bottom plates are closed, the bottom plates and the frame form a container without a box cover to temporarily store picked gloves;
and when temporarily stored gloves reach a set number, the bottom plates are opened, the gloves are separated from the temporary glove storage mechanisms.

8. The glove demolding mechanism of claim 3, wherein the second induction device further comprises a speed induction member for inducing forward motion speeds of the hand molds in real time, and information induced by the speed induction member is used for regulating forward motion speeds of the glove demolding units driven by the horizontal power assembly to ensure that the glove demolding units and the hand molds synchronously move forwards.

9. A glove counting machine, comprising the glove demolding mechanism of claim 6, further comprising delivery mechanisms;
each of the delivery mechanisms comprises delivery assemblies and storage boxes arranged on the delivery assembly, the storage boxes are located below the temporary glove storage mechanisms, the number of the delivery assemblies is consistent with that of the temporary glove storage mechanisms, and the delivery assemblies is capable of driving the storage boxes to do straight reciprocating motion in a direction away from/close to the temporary glove storage mechanisms.

10. A glove counting machine, comprising the glove demolding mechanism of claim 7, further comprising delivery mechanisms;
each of the delivery mechanisms comprises delivery assemblies and storage boxes arranged on the delivery assembly, the storage boxes are located below the temporary glove storage mechanisms, the number of the delivery assemblies is consistent with that of the temporary glove storage mechanisms, and the delivery assemblies is capable of driving the storage boxes to do straight reciprocating motion in a direction away from/close to the temporary glove storage mechanisms.

11. A glove counting machine, comprising the glove demolding mechanism of claim 8, further comprising delivery mechanisms;
each of the delivery mechanisms comprises delivery assemblies and storage boxes arranged on the delivery assembly, the storage boxes are located below the temporary glove storage mechanisms, the number of the delivery assemblies is consistent with that of the temporary glove storage mechanisms, and the delivery assemblies is capable of driving the storage boxes to do straight reciprocating motion in a direction away from/close to the temporary glove storage mechanisms.

12. The glove counting machine of claim 9, comprising a transfer mechanism, the transfer mechanism comprises a horizontal moving assembly, a vertical moving assembly and fetching jaws, the vertical moving assembly is arranged on the horizontal moving assembly, the fetching jaws are arranged on the vertical moving assembly, the horizontal moving assembly is capable of driving the vertical moving assembly to do straight reciprocating motion in horizontal direction, and the vertical moving assembly is capable of driving the fetching jaws to do straight reciprocating motion in vertical direction.

13. The glove counting machine of claim 10, comprising a transfer mechanism, the transfer mechanism comprises a horizontal moving assembly, a vertical moving assembly and fetching jaws, the vertical moving assembly is arranged on the horizontal moving assembly, the fetching jaws are arranged on the vertical moving assembly, the horizontal moving assembly is capable of driving the vertical moving assembly to do straight reciprocating motion in horizontal direction, and the vertical moving assembly is capable of driving the fetching jaws to do straight reciprocating motion in vertical direction.

14. The glove counting machine of claim 11, comprising a transfer mechanism, the transfer mechanism comprises a horizontal moving assembly, a vertical moving assembly and fetching jaws, the vertical moving assembly is arranged on the horizontal moving assembly, the fetching jaws are arranged on the vertical moving assembly, the horizontal moving assembly is capable of driving the vertical moving assembly to do straight reciprocating motion in horizontal direction, and the vertical moving assembly is capable of driving the fetching jaws to do straight reciprocating motion in vertical direction.

15. The glove counting machine of claim 12, wherein the fetching jaws are connected with the vertical moving assembly by a rotating member and the rotating member is capable of driving the fetching jaws to rotate.

16. The glove counting machine of claim 15, wherein the transfer mechanism further comprises a third driving member, the fetching jaws are arranged at two sides of the third driving member, the third driving member is connected with the rotating member, and the third driving member drives the fetching jaws to be opened or closed.

17. A glove demolding method, used in the glove demolding mechanism of claim 6, specifically comprising the following steps:
a horizontal power assembly drives glove demolding units and hand molds to synchronously move forwards;
a vertical power assembly drives the glove demolding units to move upwards to positions at heights H of the lowest ends of gloves, first driving members drive clamping jaws to be closed to clamp the gloves;
when the glove demolding units move forwards to first positions, the horizontal moving assembly decelerates till stops moving, and meanwhile, the vertical power assembly drives the glove demolding units to move downwards to pull downwards the gloves from the hand molds;
when the glove demolding units move downwards to second positions, the horizontal power assembly drives the glove demolding units to move backwards, second driving members drive the first driving members to rotate downwards and then drive the clamping jaws to rotate downwards, so that the gloves on the clamping jaws are located at front ends of the glove demolding units; and
the horizontal power assembly drives the glove demolding units to continue to move backwards, and the gloves are dragged backwards until the gloves completely enter temporary glove storage mechanisms, and then, the first driving members drive the clamping jaws to be opened, so that the gloves are placed in the temporary glove storage mechanisms.
